(19) United States
(12) Patent Application Publication
(10) Pub. No.: US 2025/0322760 A1
(43) Pub. Date: Oct. 16, 2025

(54) GAZE DETECTOR

(71) Applicant: 2hr Learning, Inc., Austin, TX (US)

(72) Inventors: Dorukhan Tokay, Istanbul (TR); Ashish Mandal, Bengaluru (IN)

(73) Assignee: 2hr Learning, Inc., Austin, TX (US)

(21) Appl. No.: 19/177,486

(22) Filed: Apr. 11, 2025

Related U.S. Application Data
(60) Provisional application No. 63/633,007, filed on Apr. 11, 2024.

(51) Int. Cl. G09B 5/02; G06F 3/01; G06T 7/246; G06T 7/277; G06T 7/73; G06T 7/80; G06V 10/766; G06V 10/774; G06V 40/19; G06V 40/20

(52) U.S. Cl. CPC G09B 5/02; G06F 3/013; G06T 7/246; G06T 7/277; G06T 7/73; G06T 7/80; G06V 10/766; G06V 10/774; G06V 40/19; G06V 40/20; G06T 2207/20081; G06T 2207/30201

(57) ABSTRACT

A gaze detection environment includes an online learning platform and a gaze detection system. A gaze detection module is integrated within the online learning platform and is initialized to monitor user engagement. The gaze detection module is calibrated to track the eye movement of the user in real-time and capture the eye gaze data which includes one or more eye coordinates. The gaze detection system processes the captured eye gaze data for detecting off-screen events by streaming the eye gaze data in real-time. The pre-defined screen edges are defined which includes an outer area of the screen. Further, the extracted gaze details are compared with the pre-defined screen edges to identify the off-gaze event and generate an alert if the user's gaze location is identified within the pre-defined screen edges for a pre-defined time. A notification module displays the generated alert to notify the user about the detected off-screen event.

### CROSS-REFERENCE TO RELATED APPLICATION

This application claims the benefit under 35 U.S.C. § 119 (e) and 37 C.F.R. § 1.78 of U.S. Provisional Application No. 63/633,007, filed Apr. 11, 2024, which is incorporated by reference in its entirety.

### FIELD OF THE INVENTION

The present invention relates in general to the field of electronics, and more specifically to gaze detection for online learning platforms which tracks the eyes of the users to monitor the engagement of the user during the online learning session.

### BACKGROUND OF THE INVENTION

Over the years online learning has become increasingly popular among learners. Technology advancement has made it more accessible and convenient for learners of all ages and backgrounds to access educational resources and courses from anywhere with an internet connection. is resulting in many effects on the attention span of users. Additionally, the flexibility of online learning allows learners to balance their studies with work, family, and other commitments more easily than traditional in-person classes. This flexibility, coupled with the ability to learn at one's own pace, has contributed to the growing popularity of online learning platforms and courses.

Monitoring learner's engagement during online learning is essential for optimizing the learning experience, improving learning outcomes, and ensuring the success of both students and educational institutions. Various mechanisms are used to monitor the engagement of learners while pursuing online courses. For example, checking how much time learners spend on each learning module, how frequently they access course materials, and their interactions with the content are few indicator of learner's engagement levels. Further, the online platforms monitor learners' performance using quizzes, tests, and assignments. Consistently high or improving grades may suggest active participation and comprehension of the course content.

In the dynamic realm of education, there's a constant search to refine teaching methodologies and enhance learning experiences. Central to this attempt is the monitoring of user engagement which is an important factor in evaluating user efficacy and achieving optimal learning outcomes. Traditional methods of engagement assessment often rely on subjective evaluations or indirect metrics like test scores, which may not provide real-time insights into user's attention and involvement.

### SUMMARY

One or more embodiment of a method include:
accessing an online learning platform through a user device, wherein the user device includes a screen and a webcam;
initializing a gaze detection module integrated within the online learning platform, wherein the gaze detection module is coupled to the webcam;
calibrating the gaze detection module for tracking eye movement of the user in real-time while the user is using the online learning platform;
capturing eye gaze data using the gaze detection module, wherein the eye gaze data identifies the gaze direction of the user's eyes while the user is accessing the online learning platform;
processing the captured eye gaze data for detection of one or more off-screen events while the user is using the online learning platform, wherein processing the captured eye gaze data comprises:
   extracting one or more gaze details from the captured eye gaze data, wherein the gaze detail includes x and y coordinates of the user's eye position and a timestamp when the gaze detail is captured;
   pre-defining screen edges, wherein the screen edges define an outer area of the screen;
   comparing the extracted one or more gaze details with the pre-defined screen edges for identifying an off-screen event, wherein an alert is generated if the user's gaze location is identified outside the screen edges for a pre-defined time;
   displaying the generated alert via a user interface on the online learning platform for notifying the user about the detected off-screen event.

One or more embodiments of a system include:
an online learning platform accessible via a user device, wherein the user device includes a user interface, a screen, and a webcam;
a gaze detection module integrated within the online learning platform to monitor the engagement behavior of a user accessing the online learning platform; wherein the gaze detection module is configured to:
   calibrating the gaze detection module for tracking the eye movement of the user in real-time while the user is using the online learning platform;
   capturing eye gaze data using the gaze detection module, wherein the eye gaze data identifies the gaze direction of the user's eyes while the user is accessing the online learning platform;
a gaze detector system to process the captured eye gaze data for detection of one or more off-screen events while the user is using the online learning platform comprises:
   a streaming module to stream the captured eye gaze data in real-time;
   a gaze processor configured to:
      extracting one or more gaze details from the captured eye gaze data, wherein the gaze detail includes x and y coordinates of the user's eye position and a timestamp when the gaze detail is captured;
      pre-defining screen edges, wherein the screen edges define an outer area of the screen;
      comparing the extracted one or more gaze details with the pre-defined screen edges for identifying an off-screen event;
   a notification module configured to:
      generating an alert if the user's gaze location is identified outside the screen edges for a pre-defined time;
      displaying the generated alert via the user interface to notify the user about the detected off-screen event.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary gaze detection environment for online learning platforms.

FIG. 2 depicts an exemplary gaze detection process for online learning platforms.

FIG. 3 depicts a flow diagram disclosing the details of the steps involved in the gaze detection process.

FIG. 4 depicts an exemplary view of a user interface in which the user is attending an online learning session.

FIGS. 5 and 6 depict user interface displays of an online learning platform showing one or more on-screen and off-screen events of the user during online learning sessions respectively.

FIG. 7 depicts an exemplary view of a user interface in which an alert is triggered to the user when the engagement rate of the user is below a threshold during the online learning session.

FIGS. 8-10 depict exemplary data structures used for the gaze detection process.

FIG. 11 depicts an exemplary network environment in which the system of FIG. 1 and the process of FIG. 2 may be practiced.

FIG. 12 depicts an exemplary computer system.

### DETAILED DESCRIPTION

A gaze detection environment includes a gaze detector system monitoring engagement rate of a user while using an online learning platform. The gaze detector system is coupled to a user device having a screen and webcam along with other components. The user accesses the online learning platform through the user device. The webcam captures user's eyes movement and shares the data with a gaze detection module, while the user is logged into the platform. The gaze detection module is integrated within the online learning platform and integrates communication between the online learning platform and the gaze detection system. The gaze detection module can be a browser extension integrated within the online learning platform. The gaze detection module is operatively coupled to the webcam and captures eye gaze data, which identifies direction of the user's eye while he is accessing the platform. The gaze detection module is calibrated for tracking a user's eye movement in real-time while using the online learning platform. The gaze detection module 114 uses one or more calibration techniques to adjust for user's eye shape, size, and eye movement patterns, ensuring accurate and personalized eye gaze data capturing during online learning sessions.

The gaze detector module shares the eye gaze data with the gaze detection system for further processing. The gaze detection system includes a gaze processor to process the eye gaze data for detection of one or more off-screen events, where the user is looking away from the screen while using the online learning platform. The gaze processor is configured to extract one or more gaze details from the eye gaze data. The gaze detail includes the x and y coordinates of the user's eye position and a timestamp when the gaze detail is captured. The gaze processor further pre-defines the screen edges, which includes an outer area of the screen, and further compares the extracted one or more gaze details with the pre-defined screen edges for identifying an off-screen event. An off-screen event is identified if the user's gaze location is identified outside the screen edges for a pre-defined period. Subsequently, an alert is generated if the engagement rate of the user is below 80% over at least 3 minutes. The engagement rate is directly related to the number of on-screen events detected for captured eye gaze data. The environment further includes a notification module that generates the alert and displays the alert to the user via the user interface on the online learning platform, thereby notifying the user about the detected off-screen event.

The processed eye gaze data is stored in a cloud database for efficient retrieval and analysis to evaluate the engagement patterns of the user and the online learning session quality. The stored eye gaze data is further analyzed using one or more analytics tools to create insights related to user engagement on the online learning platform. The insights act as a feedback mechanism for enhancing user engagement on the platform.

The gaze detection environment presents several advantages in enhancing the effectiveness of learning experiences on the online learning platform. By integrating the eye gaze tracking feature within the browser extension of the online learning platform, the gaze detection environment offers real-time monitoring of user engagement during online learning sessions. The gaze detection environment allows immediate alerts to users when their engagement drops below predefined thresholds, fostering increased awareness and accountability for their learning behaviors. Moreover, the eye gaze data is stored in a structured format for visualization purposes, which facilitates a comprehensive assessment of session quality and engagement metrics, thereby enabling educators to identify patterns, trends, and areas for improvement.

While the gaze detection environment presented herein makes use of specific reference to the detection of on-screen and off-screen gaze behavior of the user while attending the online learning session in the online learning platform, it is to be appreciated that the description is also equally applicable for school teachers, parents teaching their child at home, the students doing self-tutoring, coaching tutors, adults learning for their career development, employees in corporate training, parents for parenting education, children for craft, music and other education, elderly people for medical guidance, medical staff for guidance and so on. The gaze detection environment is for any user who uses an online learning platform.

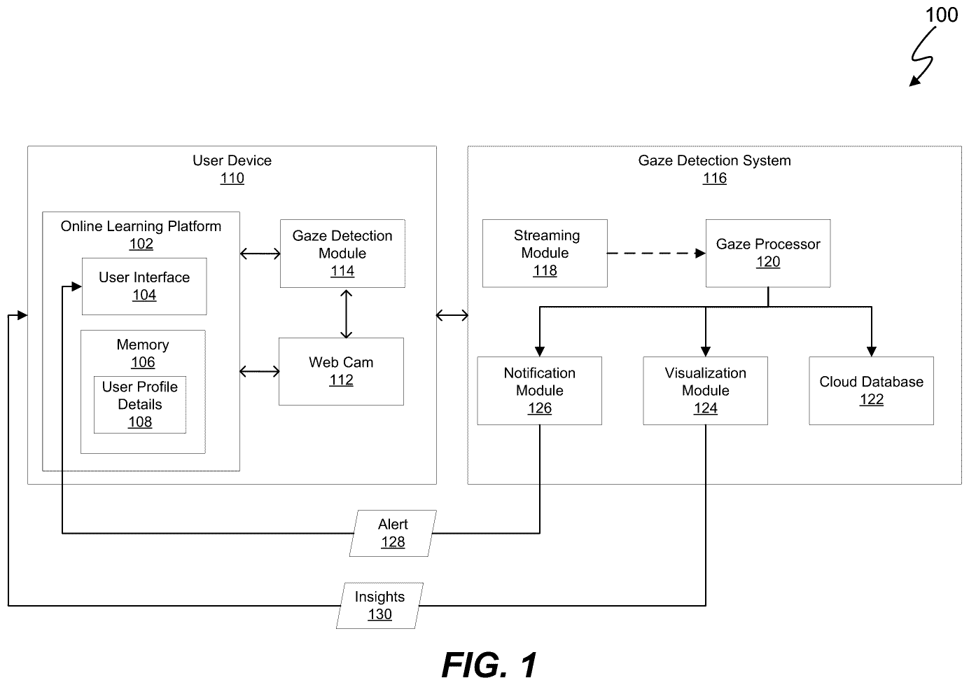

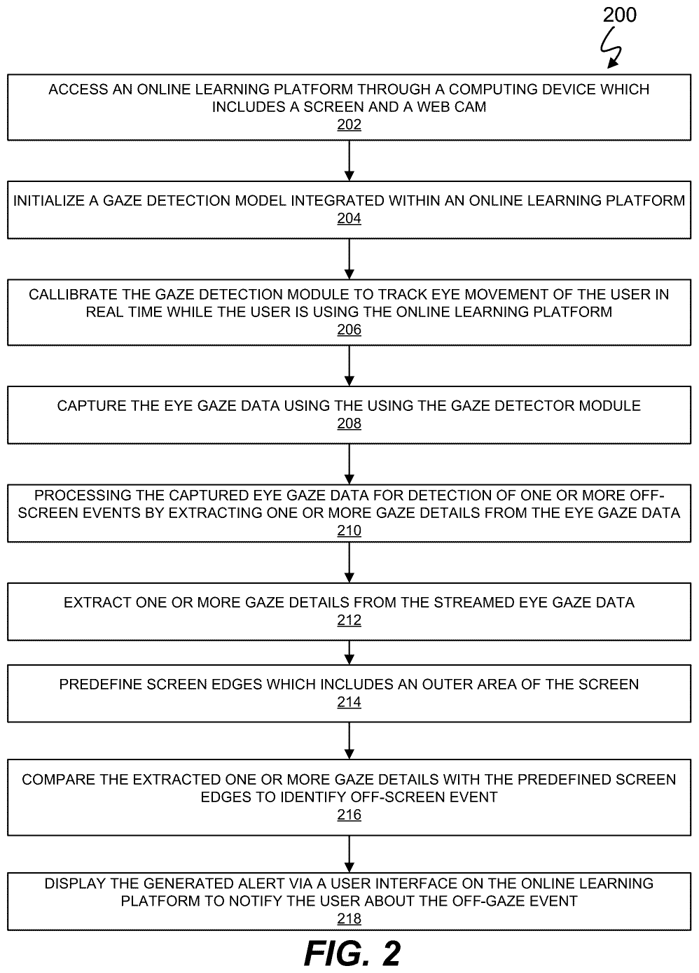

FIG. 1 depicts an exemplary gaze detection environment 100 for online learning platform 102. FIG. 2 depicts an exemplary gaze detection process 200 for online learning platform 102 utilized by the gaze detection environment 100.

Referring to FIGS. 1 and 2, in operation 202 an online learning platform 102 is accessed through a user device 110. The user device 110 includes a screen and a webcam 112. The gaze detection environment 100 integrates the online learning platform 102 to a gaze detection system 116. The online learning platform 102 includes a user interface 104 and a memory 106. The user interface 104 and memory 106 are operatively integrated. The memory 106 includes user profile details 108, including the user's personal details, session metadata like session ID, and other relevant data essential for monitoring and analyzing user engagement during online learning sessions. The memory 106 serves as a centralized repository for storing information about individual users, including demographic data, learning preferences, and engagement history.

In operation 204, the gaze detection module 114 is initialized. The initialization of gaze detection module 114 includes setting up necessary configurations, establishing connections with webcam 112 and initializing any required software libraries or modules. The gaze detection module 114, once initialized, is ready to perform eye-tracking operations within the online learning platform 102.

The gaze detection module 114 is initialized using one or more models for eye gaze tracking, which includes the ridge regression model, tensor flow mesh model, and Kalman filter. The ridge regression model, known for its robustness in handling multicollinearity and overfitting issues, contributes to refining the estimation of gaze points by using regression analysis techniques. Further, the tensor flow mesh model, known for its versatility and capability to handle complex data structures, facilitates the intricate task of mapping eye movements onto a mesh grid, thereby enabling precise localization of gaze coordinates. Additionally, the Kalman filter, recognized for its effectiveness in estimating the state of dynamic systems amidst noise and uncertainty, helps in smoothing and predicting the trajectory of eye movements, thus ensuring a more stable and consistent gaze tracking experience.

The gaze detection module 114 upon initialization becomes an integral part of the functionality of the online learning platform 102, enabling the real-time tracking and assessment of how user interacts with the online learning platform 102 during a session. The gaze detection module 114, by using advanced eye-tracking technology, continuously monitors and captures user's gaze behavior as they navigate through the learning materials and interact with the user interface 104 during the online learning session. This continuous monitoring of gaze behavior includes tracking the direction, duration, and frequency of the user's gaze, for detection of on-screen and off-screen events.

The gaze detection module 114 provides users with a seamless environment where the engagement of users is monitored without disruption. This integration eliminates the need for external devices or additional software, streamlining the user experience while still providing powerful insights into engagement behavior. Additionally, by monitoring user engagement behavior within the online learning platform 102 itself, educators gain a holistic understanding of how users interact with various learning materials and features, enabling them to make informed decisions about instructional design, content delivery, and intervention strategies.

In operation 206, the gaze detection module 114 is calibrated to track the eye movement of the user in real-time while the user is using the online learning platform 102. The calibration process involves fine-tuning the gaze detection module's algorithm and parameters to accommodate variations in eye shape, size, and eye movement patterns for different users. This calibration is typically performed using a calibration routine integrated into the online learning platform 102, where users are guided through a series of calibration tasks. During calibration, users may be prompted to focus on specific points or perform predefined eye movements to facilitate accurate calibration of the gaze detection module 114. The gaze detection module 114 adjusts its tracking mechanisms after calibration, to accurately capture and interpret the user's gaze movements during the online learning sessions.

The gaze detection module 114 is calibrated with the webcam 112 integrated into a user device 110. The gaze detection module 114 and the webcam 112 are operatively coupled to each other. The calibration process allows delaying during the start of data transmission until a threshold number of calibration clicks have been made to ensure the accuracy of the user's eye gaze.

The gaze detection module 114 optimizes its performance using this calibration technique to accurately capture and interpret the user's gaze event, both on and off the screen, with precision and consistency. The gaze detection module 114 employs calibration techniques that accommodate the individual variances in the user's eye characteristics. These techniques may involve adjustments to parameters such as sensitivity, tracking speed, or gaze mapping algorithms to account for differences in eye anatomy and behavior among users. The gaze detection module 114 incorporates personalized calibration techniques which ensures that the eye gaze data captured during online learning sessions accurately reflects the user's actual gaze event, minimizing inaccuracies and improving the overall reliability. For instance, the initially captured 100-200 eye gaze data are not used for the detection of the on-gaze and off-gaze events of the user. But they are used for calibrating the gaze detection module 114.

In operation 208, the gaze detection module 114 operatively coupled with the webcam 112 of the user device 110 captures the eye gaze data of the user, interacting with the online learning platform 102 during the online learning session. The eye gaze data identifies the gaze direction of the user's eyes while the user is accessing the online learning platform 102. The webcam 112 or other eye-tracking hardware integrated into the user's device 110 continuously monitors the user's gaze. The gaze detection module 114 captures the x and y coordinates of the user's gaze at regular intervals, along with timestamps indicating the occurrence of each gaze event. Additionally, the gaze detection module 114 captures metadata such as session ID to associate gaze data with specific learning sessions or users.

The captured eye gaze data is defined in a structured format within the gaze detection module 114 in such a way that the eye gaze data is organized in the form of packets, where each packet includes a particular bundle of eye gaze data to be transferred to a streaming module 118 for real-time streaming.

The integration of the gaze detection module 114 with the webcam 112 of the user device 110 allows real-time monitoring and recording of the user's eye movements as they engage with the online learning platform 102 during the online learning session. The gaze detection module 114 utilizes advanced eye-tracking technology to accurately capture the direction, duration, and frequency of the user's gaze, both on-screen and off-screen. By coupling with the webcam 112, the gaze detection module 114 gains access to high-quality video input, enabling precise detection and interpretation of subtle changes in the user's eye behavior. The synchronized operation ensures that the captured eye gaze data reflects the user's actual focus and attention during online learning sessions, and provides valuable insights into their engagement levels and interaction patterns.

In operation 210, a streaming module 118 operatively coupled to the gaze detection system 116 streams the gaze data in real-time. The gaze detection module 114 after capturing the eye gaze data transfers the eye gaze data to the streaming module 118 for further processing.

The streaming module 118 provides the real-time streaming of the eye gaze data. The one or more off-gaze events analysis includes identifying specific off-screen gaze events indicative of distractions, allowing for targeted interventions to enhance user focus during online learning sessions. The streaming module 118 is operatively coupled to the gaze detection module 114 from where the streaming module 118 receives the captured eye gaze data. Streaming module 118 facilitates the real-time transmission of eye gaze data as users interact with the online learning platform 102. The transfer of eye gaze data typically occurs within the backend infrastructure of the online learning platform 102. The captured eye gaze data is packaged into a structured format suitable for streaming. This structured data may include additional metadata such as session identifiers or user details to contextualize the eye gaze data. Subsequently, the gaze detection module 114 initiates the transfer of this structured eye gaze data to the streaming module 118 through a predefined communication channel (not shown in the Figure).

The streaming module 118 initiates the process of streaming eye gaze data in real-time after receiving the structured eye gaze data from gaze detection module 114. The streaming module 118 employs a robust and scalable streaming protocol, such as HTTP, to facilitate continuous transmission of gaze data from the backend infrastructure to the processing part. This protocol ensures reliable and low-latency data delivery, crucial for maintaining the real-time nature of the streaming process.

The streaming module 118 transmits the eye gaze data in real-time which enables the gaze detection system 116 to monitor user engagement dynamically as it occurs during online learning sessions. This information enables the gaze detection system 116 to accurately analyze the user's visual attention and identify off-gaze events, where the user's gaze is deviated away from the screen or primary content area.

In operation 212, a gaze processor 120 processes the streamed eye gaze data for detecting one or more off-screen events while the user uses the online learning platform 102. To accomplish the processing of eye gaze data, the gaze detection system 116 utilizes a gaze processor 120 that extracts one or more gaze details from the streamed eye gaze data. The gaze processor 120 is configured to extract key gaze details from the captured eye gaze data, including the x and y coordinates of the user's eye position and the corresponding timestamp indicating when each gaze detail is captured. These extracted gaze details provide crucial insights into the user's visual attention and movement patterns over time. The x and y coordinates of the user's eye position pinpoint the precise location on the screen where the user is focusing, while the timestamp provides temporal context, indicating when each gaze detail occurs during the user's session.

In operation 214, the gaze processor 120 pre-defines screen edges defining an outer area of the screen. The pre-defined screen edges establish the boundaries within which the user's off-gaze event is monitored and analyzed. These pre-defined screen edges serve as reference points that describe an outer area of the screen. The pre-defined screen edges are dynamically adjustable based on user preferences or design requirements allowing for flexible adaptation to different learning contexts and environments.

The gaze processor 120 pre-define screen edges by establishing outer boundaries on the screen to define regions of interest for detecting the off-gaze events. The pre-defined screen edges are defined within the backend infrastructure of the online learning platform 102. The gaze processor 120 utilizes image processing algorithms and edge detection techniques to analyze the display area of the online learning platform 102 and identify the boundaries of the screen. These boundaries may correspond to the edges of the display area visible to the user within the browser window or user interface 102. The gaze processor 120 then pre-defines screen edges based on these identified boundaries, establishing a predefined region of interest for off-gaze detection. For example, if the display area of the online learning platform 102 occupies 95% of the browser window's width and height, the gaze processor 120 may pre-define screen edges corresponding to the outer 5% of each dimension.

These pre-defined screen edges create an outer boundary that encloses the central content region displayed on the screen. The central content area typically contains the educational materials, interface elements, and interactive components of the online learning platform 102. The space outside of the pre-defined screen edges represents areas beyond the primary content display which are off-screen areas.

In operation 216, the gaze processor 120 compares the extracted one or more gaze details with the pre-defined screen edges for identifying an off-screen event. In operation 218, the gaze processor 120 transforms the captured and extracted information identifying an off-screen event into an alert 128 if the user's gaze location is identified outside the screen edges for a pre-defined time. The alert enables evaluation and improvement of engagement patterns of the user and the online learning session quality.

One or more off-screen events are detected when the user is looking beyond the pre-defined screen edges and one or more on-screen events are detected when the user is looking within the pre-defined screen edges. The gaze processor 120 processes the captured eye gaze data by utilizing one or more machine learning algorithms to personalize the off-screen events for individual users. For this purpose, one or more machine learning algorithms learn from raw data, which includes gaze details of the user from past sessions including eye coordinates data, pupil position, eye movement data, and head orientation data captured at a plurality of timestamps. The user's changing gaze patterns are adapted over the past online learning session to calibrate the detection of the off-screen events by the gaze detection module 114.

The gaze processor 120 processes the captured eye gaze data to detect off-screen events during user engagement with the online learning platform 102 during online learning sessions. Firstly, the gaze processor 120 assigns a constant value to define the screen edges, establishing the outer boundaries of the screen. Following this, the screen bounds are defined by encompassing minimum and maximum values for both screen width (minX, maxX) and screen height (minY, maxY). These screen bounds serve as reference points against which the x and y coordinates of the user's eye position, captured at various timestamps, are compared. Specifically, the x coordinate is evaluated against the minimum and maximum values for screen width, while the y coordinate is assessed against the corresponding bounds for screen height. Subsequently, the gaze processor 120 identifies off-screen events based on predefined conditions. An off-screen event is flagged if the x coordinate of the user's eye position falls below the minimum screen width, exceeds the maximum screen width, is below the minimum screen height, or surpasses the maximum screen height.

The screen bounds are defined by detecting off-screen events during user engagement with an online learning platform. The screen bounds refer to the defined boundaries or limits of the screen area within which the user's gaze is expected to remain during interaction with an online learning platform 102. The screen bounds include the minimum and maximum values for both screen width and screen height. These bounds are calculated based on a predetermined constant value representing the proportion of the screen width and height that is considered as the boundary area, which is specified as 0.05 in the present gaze detection environment 100.

The calculation of screen bounds involves determining the innermost and outermost limits of the screen area, beyond which the user's gaze is considered off-screen. This ensures that any deviation of the user's gaze outside of these boundaries triggers the detection of off-screen events. This includes calculating the minimum and maximum values for both screen width and screen height based on a predetermined constant value representing the screen edges. These calculations are fundamental for accurately explaining the permissible visual area within which the user's gaze is expected to remain during interaction with the online platform 102.

To achieve this, the gaze processor 120 uses mathematical formulas to compute the boundaries of the screen. Firstly, the minimum value of screen width (minX) is determined by multiplying the total screen width by the constant value representing the screen edges. This calculation establishes the innermost boundary of the screen, beyond which the user's gaze is considered off-screen. Conversely, the maximum value of screen width (maxX) is calculated by subtracting the product of the screen width and the screen edges constant from the total screen width. This computation defines the outermost limit of the screen, marking the boundary beyond which off-screen gaze events are detected.

This comparison operation is crucial for detecting off-gaze events and determining whether the user's gaze remains within the specified screen boundaries for a predefined duration. For example, if the pre-defined screen edges are defined such that the outer 5% of the display area is considered off-screen, the gaze processor 120 evaluates each set of eye gaze coordinates to determine if they fall within this off-screen region. If the gaze coordinates indicate that the user's gaze remains within the pre-defined screen edges for a predefined time threshold, an alert 128 is generated, signaling a potential off-gaze event. By comparing eye gaze coordinates with the pre-defined screen edges, the gaze processor 120 enables the detection of user engagement behaviors and facilitates proactive intervention to enhance the learning experience. The gaze processor 120 determines the location of the eye coordinates based on the location of the cursor of the user's mouse or the location where the user clicks with his/her mouse.

By establishing these pre-defined screen edges, the gaze detection system 116 gains a spatial reference framework for analyzing the user's one or more off-gaze events relative to the screen. During the monitoring process, the gaze processor 120 tracks one or more eye coordinates of the user's gaze and compares them with the positions of the pre-defined screen edges. This comparison allows the gaze processor 120 to determine whether the user's gaze remains within the pre-defined screen edges or beyond them. Further, if the cursor of the user's mouse points within the pre-defined screen edges, then the gaze event is defined as an on-screen gaze event, and when the cursor of the user's mouse is beyond the pre-defined screen edges then the gaze event is defined as off-screen gaze event. During this timestamp, the gaze processor 120 while comparing the eye gaze data and pre-defining screen edges identifies that the user is looking at the screen in the former case and the user is deviated and is looking somewhere outside the screen in the latter case.

The gaze processor 120 serves as the backbone of the gaze detection system 116 and plays a critical role in processing the streamed eye gaze data to identify the user's gaze location relative to the pre-defined screen edges. The gaze processor 120 of the gaze detection system 116 employs sophisticated machine learning algorithms to personalize the identification of off-screen events for individual users. By continuously monitoring and processing the eye gaze data in real-time, the gaze processor 120 determines whether the user's eye gaze falls within the pre-defined screen edge or deviates beyond the defined boundaries.

When the gaze processor 120 identifies that the user's gaze location remains within the pre-defined screen edges for a predefined duration, it triggers the generation of an alert 128. This alert 128 serves as an alert mechanism to signal the occurrence of an off-gaze event, indicating that the user's attention may have shifted away from the central content area of the screen. By establishing a predefined time threshold for detecting off-gaze events, the gaze processor 120 can differentiate between momentary distractions and sustained periods of disengagement, ensuring that alerts 128 are generated only when significant deviations from the expected gaze behavior occur. For example, in the present gaze detection environment 100, alert 128 is triggered if the user is not looking at the screen for 80% of the time during a timestamp of 3 minutes.

The generation of alert 128 in response to the off-gaze events serves as a proactive measure to prompt intervention or provide feedback to the user, encouraging the user to refocus their attention on the learning material. These alerts 128 may take various forms, such as visual alerts within the user interface 104 or audible cues, depending on the design preferences of the online learning platform 102. The generation of real-time alerts 128 to the user serves as a proactive measure to address instances of off-screen gaze events detected during their interaction with the online learning platform 102. These alerts 128 are not merely passive but encompass adaptive suggestions specifically designed to re-engage the user and encourage them to refocus their attention on the screen. Based on the individual user's context and learning preferences, these suggestions are dynamically generated based on the nature and duration of the detected off-screen gaze events. For example, if a user's gaze is detected to have drifted away from the screen for an extended period, the notification module 126 provides targeted prompts or interactive prompts, such as highlighting relevant content, presenting engaging multimedia materials, or suggesting interactive exercises.

The gaze detection system 116 has a cloud database 122 integrated within to store the processed eye gaze data for efficient retrieval and analysis to evaluate the engagement patterns of the user and the online learning session quality. The cloud database 122 evaluates engagement patterns and online learning session quality. The cloud database 122 also employs encryption and access control mechanisms to ensure the security and privacy of processing eye gaze data, adhering to regulatory compliance and data protection standards.

In operation 218, the notification module 126 generates the alert 128 and displays the generated alert 128 via a user interface 104 on the online learning platform 102 to notify the user about the detected off-screen event. The notification module 126 provides real-time alert 128 to the user, including adaptive suggestions tailored to re-engage the user based on detected off-screen gaze events. Further, the notification module 126 triggers alert 128 based on one or more predefined criteria, such as the percentage of time the user's gaze is off the screen during the online learning session. For example, in the present gaze detection environment 100 the notification module 126 notifies the user every 3 minutes if the user is not looking at the screen for at least 80% of the time. This is explained in detail below:

The gaze detection system 116 initiates a continuous monitoring process, observing the user's engagement and eye gaze behavior in real-time as they interact with the online learning platform 102. At regular intervals, for instance, every 3 minutes, the gaze detection system 116 calculates the user's engagement rate by analyzing the eye gaze data collected during that specific timeframe. This engagement rate reflects the percentage of time the user's gaze remains focused on the screen relative to the total duration of the monitoring period. Subsequently, the gaze detection system 116 compares the calculated engagement rate with a predefined threshold set at 80%. If the engagement rate falls below this threshold, indicating that the user has not maintained focus on the screen for more than 80% of the monitoring period, the notification module 126 proceeds to generate an alert 128. This alert 128 serves to notify the user and other relevant persons like the teacher of the student and so on about the off-gaze event, providing pertinent details such as the user's identification, session ID, timestamp, and an alert message highlighting the drop in engagement below the acceptable threshold. Through this process, the gaze detection system 116 enables proactive intervention and support measures to enhance user engagement and optimize the learning experience.

The notification module 126 utilizes the user interface 104 integrated within the online learning platform 102 and displays real-time alerts 128 to inform users about instances where their gaze has deviated from the screen during the online learning session. These alerts 128 are designed to provide immediate feedback to users, alerting them to potential distractions or lapses in engagement, and prompting them to re-focus their attention on the learning material.

The gaze detection system 116 further includes visualization module 124 which analyzes the stored eye gaze data using one or more analytics tools to create insights 130 related to user engagement on the online learning platform 102. Insights 130 acts as a feedback mechanism for enhancing user engagement on the platform. The visualization module 116 serves as a crucial component for analyzing and interpreting eye gaze data collected during online learning sessions. The visualization module 116 creates insightful and interactive visual representations of the processed eye gaze data. Using these visualizations, educators and administrators gain valuable insights 130 into user engagement patterns, attention levels, and learning behaviors. For example, visualization module 116 can generate graphical charts, diagrams, or dashboards showcasing metrics such as on-screen gaze duration, off-screen gaze event occurrences, overall engagement rates over time, and so on. Additionally, the visualization module 116 enables users to customize and explore the data according to their specific analytical needs and interests. By providing clear and intuitive visualizations of the eye gaze data, the visualization module 116 facilitates informed decision-making, strategic planning, and targeted interventions to optimize the learning experience for users. Moreover, the visualization module 116 ensures scalability, flexibility, and accessibility in generating and sharing visual insights 130 across the online learning platform 102, ultimately enhancing the effectiveness of the online learning platform 102 in monitoring and improving user engagement during online learning sessions.

The gaze detection environment 100 offers several advantages that significantly enhance the online learning experience. Firstly, by integrating a gaze detection feature within the online learning platform 102, the gaze detection environment 100 enables real-time monitoring of user engagement levels during online learning sessions. This proactive approach allows educators to identify and address potential distractions or disengagement, thereby promoting a more focused and interactive learning environment. Moreover, the gaze detection environment 100 provides personalized alerts 128 and adaptive suggestions customized to re-engage users based on their gaze behavior enhancing the effectiveness of intervention strategies and ultimately improving learning outcomes. Additionally, the structured storage and visualization of gaze data facilitate comprehensive analysis and assessment of user engagement patterns, enabling educators to gain valuable insights 130 for optimizing instructional design and content delivery. Overall, the gaze detection environment 100 represents a solution that makes use of eye-tracking technology to revolutionize online learning, empowering educators to better understand and support user engagement and learning processes in the online learning platform 102.

The below pseudo-code represents exemplary structured data for off-gaze event and on-gaze event detection and notifying the user in case of an off-gaze event by using “gaze detection environment 100”:

```
            // Initialize WebGazer and set up parameters for eye-
tracking
      function initializeWebGazer( ) {
            webgazer.setRegression(‘ridge’) // Use ridge regression
model for predictions
              .setTracker(‘TFFacemesh’) // Use TensorFlow Facemesh
model for tracking
              .showPredictionPoints(false) // Do not show prediction
points on the screen
              .showVideo(false) // Do not show the video feed
              .saveDataAcrossSessions(true) // Save data across browser
sessions
              .applyKalmanFilter(true) // Apply Kalman filter for
smoother predictions
              .begin( ); // Start the eye-tracking
      }
      // Function to check if the user's gaze is off the screen
      function isGazeOffScreen(gazeData) {
            const edgeProximity = 0.05;
            const minX = screenWidth * edgeProximity;
            const maxX = screenWidth * (1 − edgeProximity);
            const minY = screenHeight * edgeProximity;
            const maxY = screenHeight * (1 − edgeProximity);
            // Check if the gaze coordinates are outside the defined
screen bounds
            return (gazeData.x < minx || gazeData.x > maxx ||
gazeData. y < minY || gazeData.y > maxY);
      }
      // Function to handle gaze data and send it to AWS Kinesis
      function handleGazeData(gazeData) {
            if (isGazeOffScreen(gazeData)) {
            // Prepare the data payload for AWS Kinesis
            const payload = {
                  ‘studentId’: studentId,
                  ‘sessionId’: sessionId,
                  ‘gazeData’: gazeData,
                  ‘timestamp’: getCurrentTimestamp( )
            };
            // Send the gaze data to AWS Kinesis for real-time
processing
            sendToKinesis(payload);
            }
      }
      // Function to send data to AWS Kinesis
      function sendToKinesis(payload) {
            // Convert payload to JSON and send to Kinesis stream
            kinesis.putRecord({
            StreamName: ‘AlphaCoachGazeStream’,
            Data: JSON.stringify(payload),
            PartitionKey: payload.studentId
            });
      }
      // Function to set up a timer to check engagement every 3 minutes
      function setupEngagementTimer( ) {
            setInterval(( ) => {
            // Query AWS Athena to calculate engagement over the last 3
minutes
            const engagementRate = queryAthena ForEngagement(studentId,
sessionId);
            // If engagement is below 80%, send a alert using AWS SNS
            if (engagementRate < 0.8) {
                  sendEngagementalert(studentId, sessionId);
            }
            }, 3 * 60 * 1000); // Set interval for 3 minutes
      }
      // Function to send engagement alert using AWS SNS
      function sendEngagementalert(studentId, sessionId) {
            sns.publish({
            TopicArn: ‘arn:aws:sns:region:account-
id:AlphaCoachEngagementTopic’,
            Message: ‘Student ${ studentId} is not engaged.’,
            Subject: ‘Engagement Alert’
            });
      }
      // Main function to start the gaze detection and monitoring
process
      function main( ) {
            initializeWebGazer( );
            setupEngagementTimer( );
      }
      // Call the main function to execute the program
      main( );
```

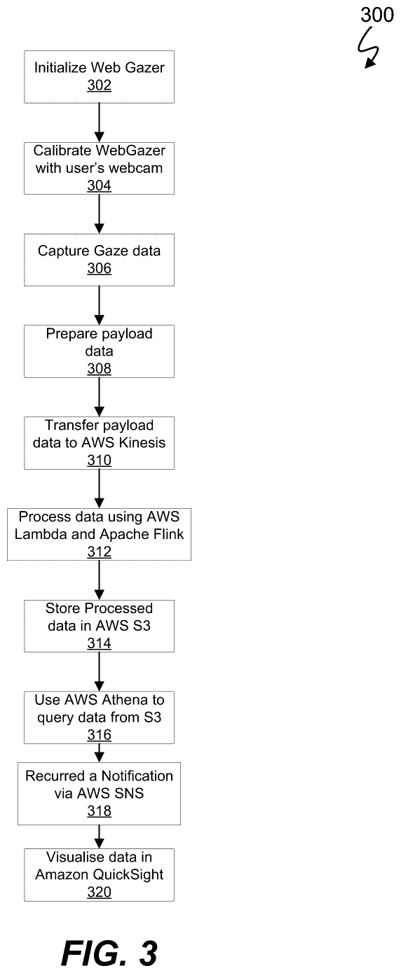

FIG. 3 depicts a flow diagram 300 disclosing the details of the steps involved in the gaze detection process 200.

The gaze detection process 200 begins with the initialization of the WebGazer 302 eye-tracking feature within the browser extension of the online learning platform, a crucial step that sets the groundwork for capturing and analyzing user engagement during the online learning session. The initialization of WebGazer 302 begins, where the feature is activated and configured to commence eye-tracking functionalities. Following initialization 302, the WebGazer is calibrated 304 with the user's webcam, ensuring precise tracking of eye movements characterized by each user's unique characteristics. Upon initialization 302, the calibration process 304 takes place, where WebGazer is fine-tuned with the user's webcam to accommodate variations in eye shape, size, and eye movement patterns. Once calibrated 304, WebGazer starts capturing eye gaze data 306 which includes one or more eye coordinates of the user.

While the gaze detection environment 100 disclosed herein makes use of Webgazer for eye tracking, it is to be appreciated that the description is also equally applicable to other eye tracking tools like Hotjar, Crazy Egg, Mouseflow, and so on.

The captured gaze data undergoes processing and structuring into payload data 308, including essential information such as one or more eye gaze coordinates and timestamps. The payload data 308 refers to the structured information containing gaze coordinates and timestamps captured by the WebGazer eye-tracking feature during online learning sessions. To transfer payload data 310 to AWS Kinesis, a multi-step process is employed. Firstly, the captured gaze data is prepared 306 and formatted into a suitable structure for streaming, ensuring it is ready for transmission 310.

Once structured, the payload data is then transmitted 310 to AWS Kinesis, a real-time streaming service, using AWS SDKs or APIs. This establishes a connection with AWS Kinesis, enabling the payload data to be seamlessly streamed to the service for immediate processing. Within AWS Kinesis, the data may undergo further partitioning into fragments for parallel processing, enhancing scalability and efficiency. Additionally, AWS Kinesis integrates seamlessly with other AWS services, allowing for comprehensive analysis and visualization of the streamed data in real-time. Through this process, payload data transfer 310 to AWS Kinesis facilitates continuous monitoring and analysis of user engagement, empowering educators to make informed decisions and optimize the online learning experience.

The AWS Kinesis seamlessly integrates with other AWS services like AWS Lambda and Apache Flink for real-time processing and analysis, enabling immediate responses to changes in the eye gaze data and facilitating the generation of actionable insights. The streamed data undergoes real-time processing 312 using AWS Lambda functions and Apache Flink, facilitating immediate analysis and extraction of valuable insights on user engagement patterns and learning behaviors.

The Apache Flink is a distributed stream processing framework that enables real-time processing of the streamed eye gaze data 312. Upon receiving the data from AWS Kinesis, Apache Flink processes the data in parallel across distributed computing nodes. This allows for efficient and scalable analysis of the eye gaze data in real-time. Within Apache Flink, various processing tasks are performed, including data transformations, filtering, and aggregation. These tasks are tailored to the specific requirements, such as identifying patterns of user engagement and detecting off-screen events.

The AWS Lambda functions complement the Apache Flink tool processing capabilities by enabling serverless computing for specific tasks within the data processing pipeline. The AWS Lambda functions are lightweight, event-driven compute services that automatically scale in response to incoming data. The AWS Lambda functions are used for tasks such as data validation, and data processing. For example, Lambda functions can be utilized to validate the incoming eye gaze data, ensuring its integrity and accuracy before further processing.

Together, Apache Flink and AWS Lambda form a robust data processing pipeline that efficiently handles the streamed eye gaze data. Apache Flink's distributed stream processing capabilities enable real-time analysis and insights 130 generations, while AWS Lambda functions provide additional flexibility and scalability for specific processing tasks.

While the gaze detection environment 100 disclosed herein makes use of AWS Kinesis for real-time streaming of the captured data to subscribed users of the online learning platform 102, it is to be appreciated that the description is also equally applicable for other tools like Azure Event Hubs, Google Cloud Pub, and so on. Further, the use of the AWS Lambda function in the gaze detection environment 100 for processing the streamed data can also be accomplished using other tools like Google Cloud Functions, Azure Functions, Apache OpenWhisk, and so on. Also, the use of Apache Flink for processing the streamed data can be made using other tools like Apache Spark Streaming, Google Dataflow, and so on.

Processed gaze data is securely stored 314 in AWS S3, which is an object storage service available from Amazon having an office in Seattle, US. Storage of eye gaze data in AWS S3 ensures accessibility for subsequent retrieval and analysis. Utilizing AWS Athena, educators can efficiently query the stored gaze data 316, empowering them to assess engagement metrics and online learning session quality comprehensively. AWS Athena operates as a query service that enables educators and administrators to analyze the stored eye gaze data efficiently. Leveraging standard SQL queries, AWS Athena allows users to retrieve specific subsets of data from AWS S3 for detailed analysis. The AWS Athena generates queries 316 to calculate engagement metrics and assess session quality based on the stored eye gaze data. By executing queries 316 against the structured data stored in AWS S3, AWS Athena facilitates the extraction of valuable insights 130 into user engagement patterns and learning behaviors.

In instances where engagement drops below predefined thresholds, an alert 128 is promptly triggered 318 via AWS SNS, providing real-time alerts 128 to students to re-engage with the learning material effectively.

The user engagement is monitored at regular intervals of every 3 minutes to ensure continuous assessment of user focus and participation during online learning sessions. Using AWS Athena, a query is generated 316 to calculate the engagement rate, analyzing factors such as the duration of on-screen gaze versus off-screen gaze within the specified time interval. Alert 128 is generated if the engagement rate of the user is below 80% for at least 3 minutes. The engagement rate is directly related to the number of on-screen events detected for captured eye gaze data. Based on this an alert 128 is promptly generated. This alert 128 serves as a proactive measure to notify educators 318 and administrators of the user's sustained engagement, providing reassurance of active participation. Additionally, an alert 128 is dispatched to the user via AWS SNS, leveraging real-time communication to inform them of their exemplary engagement behavior and potentially incentivize continued focus and involvement. Through this systematic approach of periodic engagement assessment and timely alerts 128, the gaze detection environment 100 enhances the monitoring and encouragement of user engagement.

While the gaze detection environment 100 disclosed herein makes use of AWS S3 for storing the processed data, it is to be appreciated that the description is also equally applicable to other tools like Google Cloud Storage, Microsoft Azure Blob Storage, and so on. Further, the use of AWS Athena for generating queries to analyze data can also be done using other tools like Google BigQuery, Apache Drill, Azure Data Lake Analytics, and so on.

Lastly, the analyzed eye gaze data is visualized 320 using Amazon QuickSight, offering educators comprehensive reports and visual insights 130 into user engagement patterns and learning behaviors. These visualizations play a pivotal role in informed decision-making, enabling educators to optimize instructional design and content delivery strategies to enhance the overall online learning experience for users. Amazon QuickSight operates as a business intelligence and data visualization tool, facilitating the creation of interactive dashboards and visualizations for analyzing eye gaze data. By connecting directly to AWS S3, Amazon QuickSight accesses the stored eye gaze data and generates comprehensive visual reports and insights 130. These visualizations allow educators and administrators to explore engagement metrics, track trends over time, and identify areas for improvement in the online learning experience.

While the gaze detection environment 100 disclosed herein makes use of AWS QuickSight for generating visual reports and insights 130 to subscribed users of the online learning platform 102, it is to be appreciated that the description is also equally applicable to other tools like Google Data Studio, Tableau, Microsoft Power BI and so on.

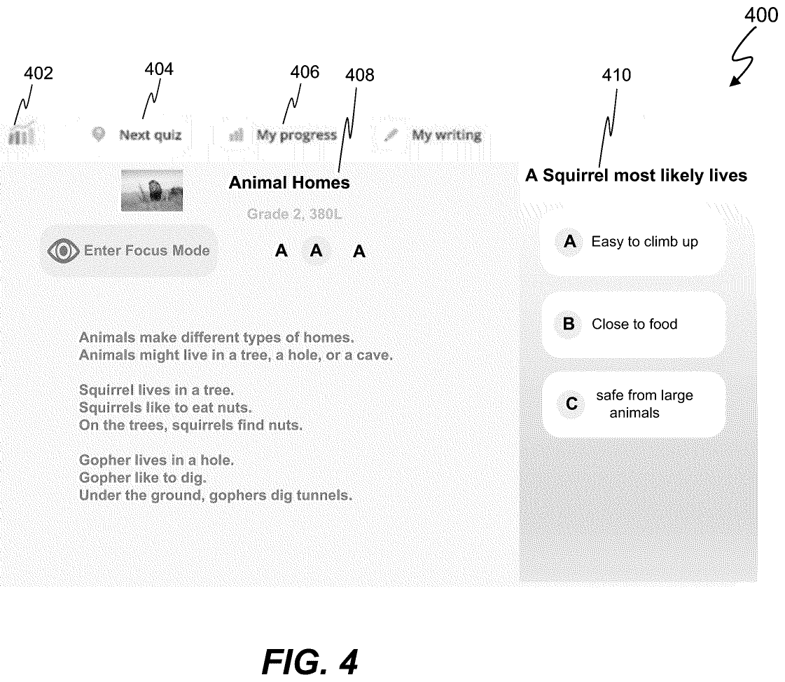

FIG. 4 depicts an exemplary view of a user interface 400 in which the user is attending the online learning session.

The user interface 400 discloses various tabs clicking on which the user can access different sections. For example, on clicking tab 402, the user can access ‘Dashboard’ where all the information related to the user is available in the form of user profile details 108. Further on clicking the next tabs 404 and 406, the user can access the tabs ‘Next Quiz, where the user can go to the next quiz during the online learning session, and ‘My Progress’ where the user can check his/her progress status. Tab 408 represents the topic i.e., ‘Animal Homes’, in the case of the present example, which the user is currently studying in the online learning platform 102, and tab 410 represents the ‘Quiz’ based on topic 408. The answers to quiz 410 are to be answered by the user based on which the progress of the user is updated.

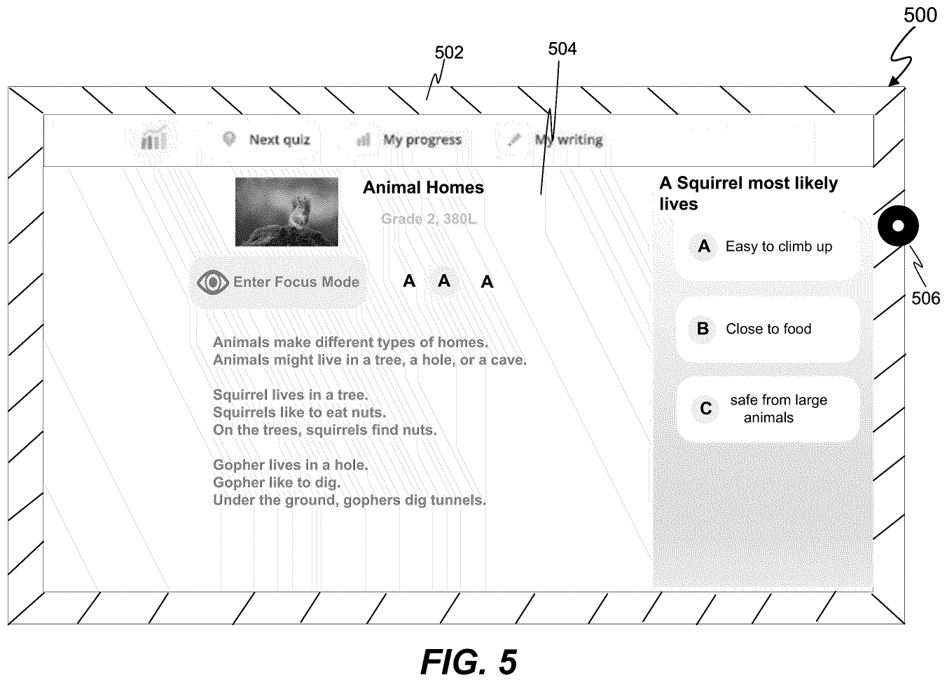

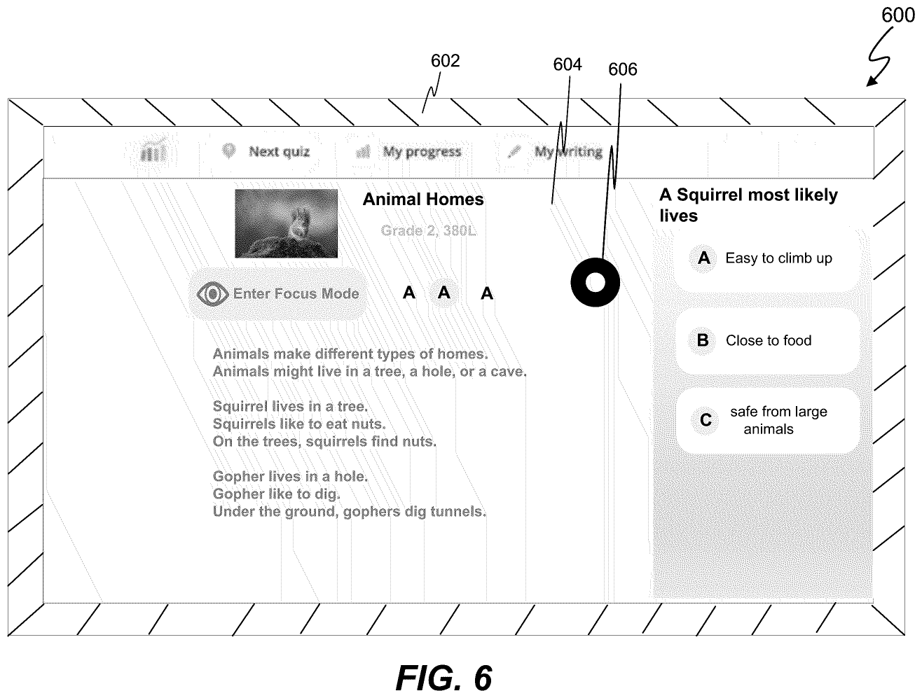

FIGS. 5 and 6 depict exemplary user interfaces 500 and 600 of online learning platform 102 showing the on-screen and off-screen events during online learning sessions, respectively.

The user interfaces 500 and 600 show when the gaze event is considered as the on-screen event and when it is considered as the off-screen event.

The gaze detection module 114 integrated within the browser extension of the online learning platform 102 captures the eye gaze data of the user who is attending his/her online learning session on learning platform 102. The gaze detection system 116 operatively coupled to the online learning platform 102 processes the eye gaze data of the user who is using the online learning platform 102 using the gaze processor 120. Based on the pre-defined screen edges, the on-screen and off-screen events of the user are detected. The gaze processor 120 extracts one or more gaze details from the captured eye gaze data. The gaze details includes x and y coordinates of the user's eye position and a timestamp when the gaze is captured. Further, the gaze processor 120 pre-defines the screen edges and compares the extracted one or more gaze details with the pre-defined screen edges for identifying an off-screen event. The off-screen event is when the user looks beyond the pre-defined screen edges and the on-screen behavior is when the user is within the pre-defined screen edges.

In the present exemplary scenario, the pre-defined screen edges 502 include 5% of the outer area on the screen. If the user's gaze 506 is identified to be in this 5% outer area, an off-screen event is detected. In contrast, if the gaze 606 is detected within the remaining inner 95% are, an on-screen event is detected.

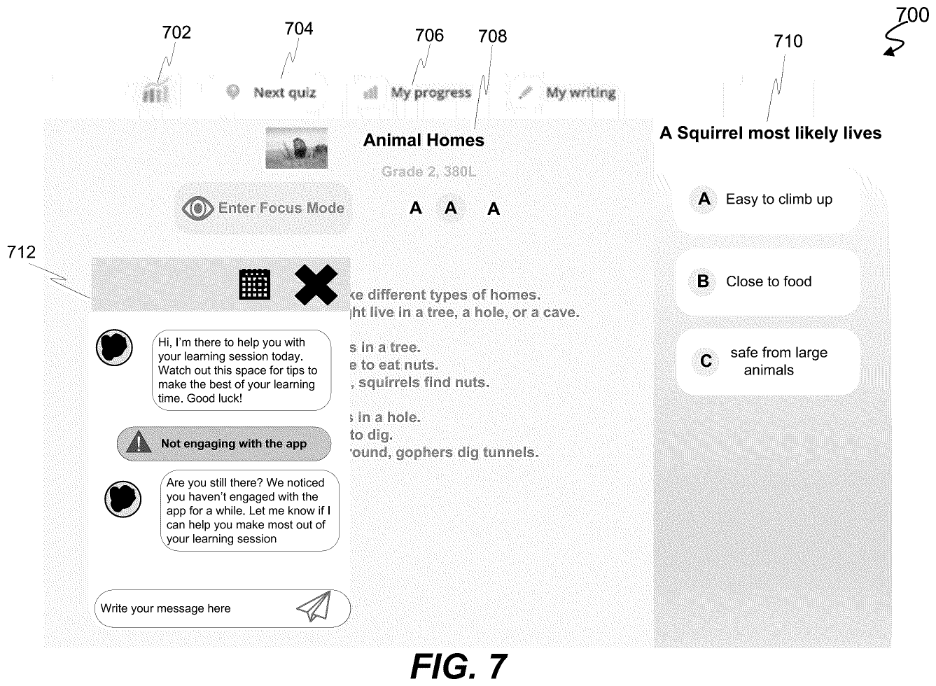

FIG. 7 depicts an exemplary user interface 700 showing an alert 712 generated when the user engagement rate drops below a threshold during an online learning session.

The user interface 700 shows various tabs including ‘Dashboard’ 702 through which the user can access information related to various past and ongoing sessions, ‘Next Quiz’ 704 to access more quizzes while he is in the session, and ‘My Progress’ 706 where the user can check his/her current progress on ongoing assignments. Further, tab 708 shows the topic i.e., ‘Animal Homes’ that the user is currently studying on the online learning platform 102, and tab 710 represents the ‘Quiz’ based on topic 708.

An alert 712 is shown to the user when his gaze location is identified within the pre-defined screen edges for a pre-defined time. The generated alert 128 is then displayed via a user interface 700 on the online learning platform 102 for notifying the user about the detected off-screen event. The notification module 126 which is operatively coupled to the user interface 700 triggers an alert 128 to the user which can be seen as tab 712 ‘Notification’. Such an alert 712 is triggered when the off-screen event exists for 80% of the time in a time interval of 3 minutes. The alert can include message ‘Not engaging with the App’, ‘Are you still there?’, and so on.

The alert 712 help users recognize when they are drifting off-task and encourage them to refocus their attention on the learning material promptly. Alert 712 provides an opportunity for timely intervention by educators or support staff. If the user consistently receives such alerts, showing low engagement, educators can reach out to offer assistance, guidance, or additional resources to address any challenges the users may be facing.

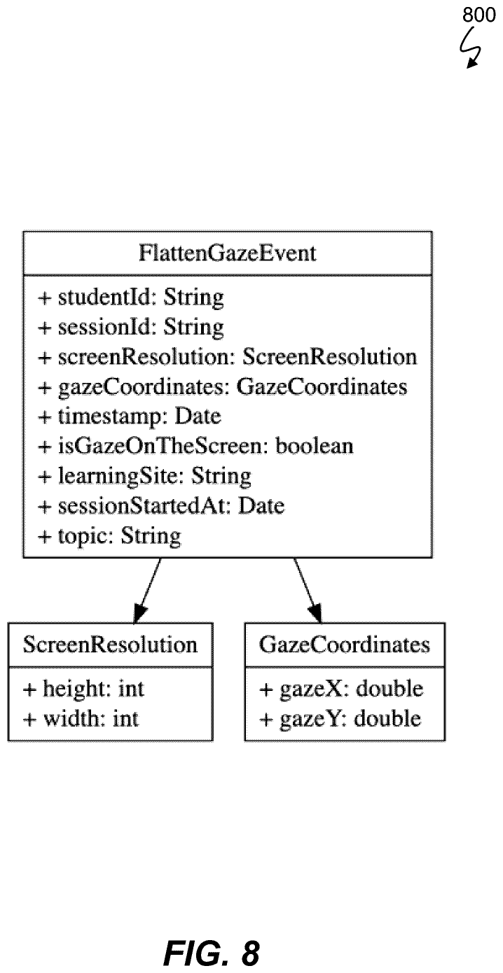

FIGS. 8-10 depict data structures 800, 900, and 1000 used for the gaze detection process 200.

FIG. 8 discloses a FlattenGazeEvent data structure 800. The FlattenGazeEvent 800 is a data structure designed to encapsulate individual gaze events occurring within the online learning platform 102. The FlattenGazeEvent data structure 800 serves as a comprehensive record of various parameters associated with each gaze event, facilitating detailed analysis of user engagement and interaction patterns. The FlattenGazeEvent data structure 800 includes essential information such as the screen resolution at the time of the off-screen and on-screen event, providing a context for interpreting eye gaze data accurately within the user interface 104. Additionally, it captures precise eye gaze data, specifying the exact location on the screen where the user's gaze is directed. Timestamps are also included, enabling temporal analysis and tracking of gaze events over time, essential for understanding changes in user engagement levels during different phases of interaction. Moreover, the FlattenGazeEvent data structure 800 incorporates an engagement status attribute, indicating the user's level of engagement at the time of the gaze event. This status can signify whether the user was actively engaged with the content or potentially distracted, aiding in the assessment of overall user attention and focus.

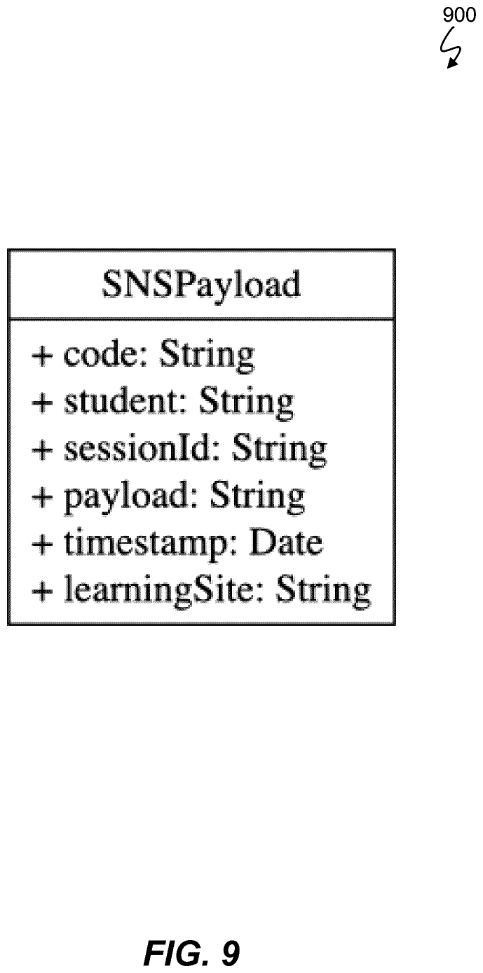

FIG. 9 discloses a SNSPayload data structure 900. The SNSPayload data structure 900 serves as a fundamental component in the generation of payloads for the Amazon Simple alert Service (SNS), a highly scalable messaging service provided by Amazon Web Services (AWS). The primary function of AWS SNS is to encapsulate pertinent information necessary for transmitting alerts 128 to subscribed users of the online learning platform 102. The SNSPayload data structure 900 includes essential elements crucial for contextualizing and processing alerts 128 effectively. These elements encompass the event code, providing a concise identifier denoting the type or category of the event triggering the alert 128. Additionally, the payload incorporates user information, furnishing details about the individual associated with the event, such as their name, identifier, or any relevant demographic data obtained from the user profile 108. The session ID is also integrated into the payload, facilitating the correlation of the event with the specific learning session or context within the online learning platform 102. Furthermore, the serialized gaze event data forms an integral part of the payload, encapsulating detailed information regarding the user's gaze behavior during the associated event. This serialized data may encompass various parameters, including gaze coordinates, timestamps, screen resolutions, and engagement status, providing comprehensive insights 130 into the user's interaction and engagement within the digital environment.

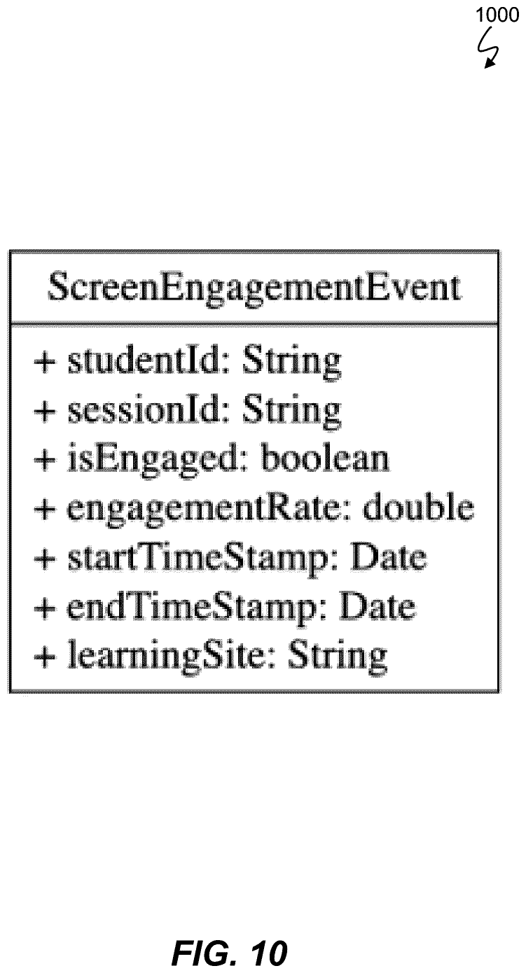

FIG. 10 discloses a ScreenEngagementEvent data structure 1000. The ScreenEngagementEvent data structure 1000 is pivotal in representing engagement events on the online learning platform 102. The ScreenEngagementEvent data structure 1000 encapsulates crucial information essential for understanding and quantifying user engagement levels during the online learning session. The ScreenEngagementEvent data structure 1000 includes identifiers such as the student ID and session ID i.e., the details of the user obtained from the user profile 108, enabling precise association of the engagement event with the corresponding user and learning session. These identifiers facilitate tracking and analysis of individual user engagement behaviors over time, fostering personalized insights 130 into learning patterns and preferences. Additionally, the ScreenEngagementEvent data structure 1000 incorporates the engagement rate, a metric quantifying the level of user involvement or interaction within the online learning platform 102. This metric may be calculated based on various factors, including the frequency and duration of interactions, the complexity of tasks undertaken, or the depth of content exploration. By quantifying engagement in this manner, the ScreenEngagementEvent data structure 1000 provides actionable insights 130 into user participation and attentiveness, facilitating targeted interventions and instructional adjustments to optimize learning experiences. Furthermore, timestamps denoting the start and end of the engagement period are included within the ScreenEngagementEvent data structure 1000, enabling temporal analysis and characterization of engagement dynamics over discrete time intervals. These timestamps provide valuable context for understanding the duration and timing of engagement events, aiding in the identification of off-screen events.

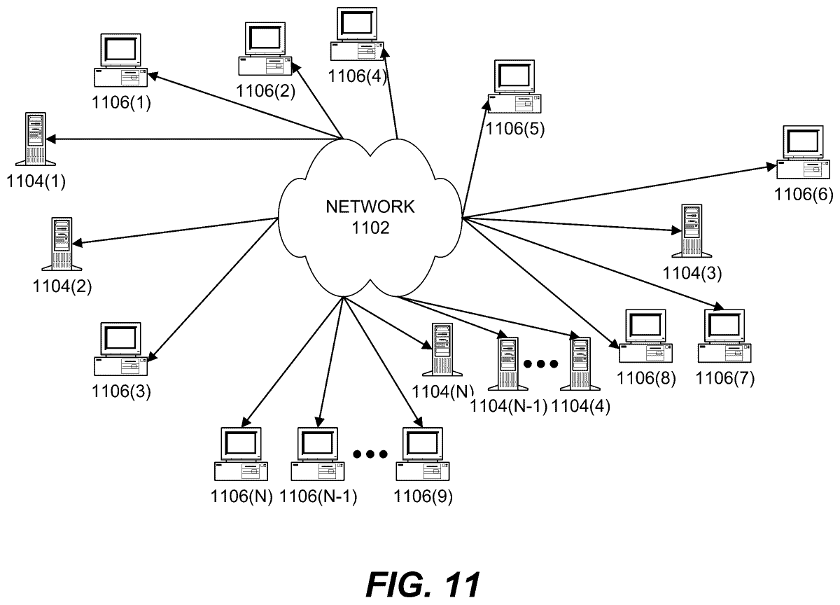

FIG. 11 is a block diagram illustrating a network environment in which a gaze detection environment 100 and process 200 may be practiced. Network 1102 (e.g. a private wide area network (WAN) or the Internet) includes several networked server computer systems 1104(1)-(N) that are accessible by client computer systems 1106(1)-(N), where N is the number of server computer systems connected to the network. Communication between client computer systems 1106(1)-(N) and server computer systems 1104(1)-(N) typically occurs over a network, such as a public switched telephone network over asynchronous digital subscriber line (ADSL) telephone lines or high-bandwidth trunks, for example, communications channels providing TI or OC3 service. Client computer systems 1106(1)-(N) typically access server computer systems 1104(1)-(N) through a service provider, such as an internet service provider (“ISP”) by executing application-specific software, commonly referred to as a browser, on one of client computer systems 1106(1)-(N).

Client computer systems 1106(1)-(N) and/or server computer systems 1104(1)-(N) are specialized computers programmed to improve conventional computer systems to implement and utilize the gaze detection environment 100 and process 200. The type of computer system that can be specially programmed to implement and utilize the gaze detection environment 100 and process 200 include a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the gaze detection environment 100 and process 200 can be implemented using code stored in a tangible, non-transient computer-readable medium and executed by one or more processors. In at least one embodiment, the gaze detection environment 100 and process 200 can be implemented completely in hardware using, for example, logic circuits and other circuits including field programmable gate arrays.

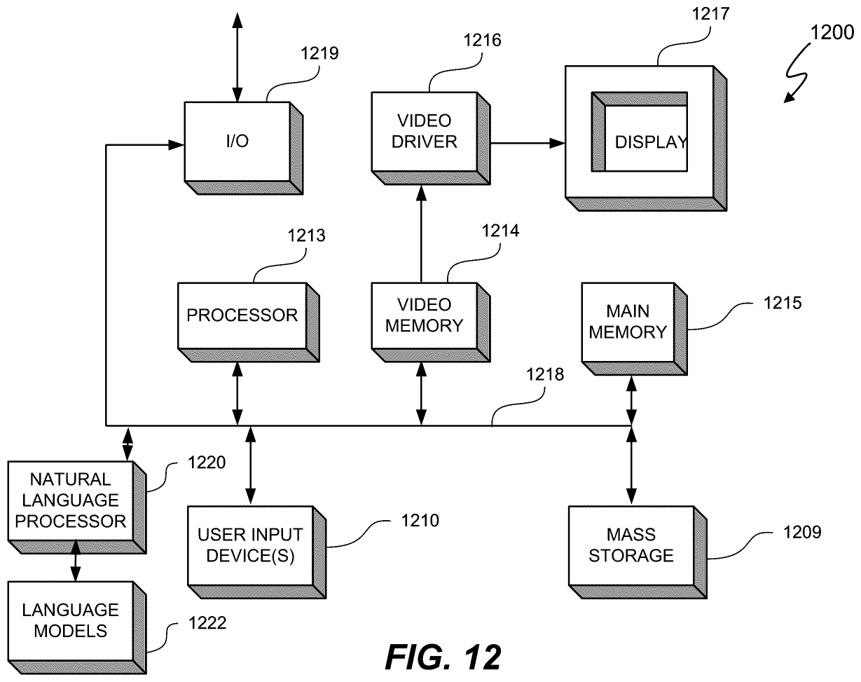

Embodiments of the gaze detection environment 100 and process 200 can be implemented on a computer system such as a special-purpose, special-programmed computer 1200 illustrated in FIG. 12. The input user device(s) 1210, such as a keyboard and/or mouse, are coupled to a bi-directional system bus 1218. The input user device(s) 1210 are for introducing user input to the computer system and communicating that user input to processor 1213. The computer system of FIG. 12 generally also includes a non-transitory video memory 1214, non-transitory main memory 1215, and non-transitory mass storage 1209, all coupled to bi-directional system bus 1218 along with input user device(s) 1210 and processor 1213. The mass storage 1209 may include both fixed and removable media, such as a hard drive, one or more CDs or DVDs, solid state memory including flash memory, and other available mass storage technology. Bus 1218 may contain, for example, 32 of 64 address lines for addressing video memory 1214 or main memory 1215. The system bus 1218 also includes, for example, an n-bit data bus for transferring DATA between and among the components, such as CPU 1209, main memory 1215, video memory 1214, and mass storage 1209, where “n” is, for example, 32 or 64. Alternatively, multiplex data/address lines may be used instead of separate data and address lines.

I/O device(s) 1219 may provide connections to peripheral devices, such as a printer, and may also provide a direct connection to a remote server computer system via a telephone link or to the Internet via an ISP. I/O device(s) 1219 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1209, into main memory 1215 for execution. Computer programs may also be in the form of electronic signals modulated following the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The one or more processors 1213, in one embodiment, are one or more microprocessor manufactured by, for example, Motorola Inc. of Illinois, Intel Corporation of California, or Advanced Micro Devices of California. However, any other suitable single or multiple microprocessors or microcomputers may be utilized. Main memory 1215 is comprised of dynamic random access memory (DRAM). Video memory 1214 is a dual-ported video random access memory. One port of the video memory 1214 is coupled to the video amplifier 1216. The video amplifier 1216 is used to drive the display 1217. Video amplifier 1216 is well-known in the art and may be implemented by any suitable means. This circuitry converts pixel DATA stored in video memory 1214 to a raster signal suitable for use by display 1217. Display 1217 is a type of monitor suitable for displaying graphic images.

The computer system described above is for purposes of example only. The gaze detection environment 100 and process 200 may be implemented in any type of computer system programming or processing environment. It is contemplated that the gaze detection environment 100 and process 200 might be run on a stand-alone computer system, such as the one described above. The gaze detection environment 100 and process 200 might also be run from a server computer systems system that can be accessed by a plurality of client computer systems interconnected over an intranet network. Finally, the gaze detection environment 100 and process 200 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method comprising:
accessing an online learning platform through a user device, wherein the user device includes a screen and a webcam;
initializing a gaze detection module integrated within the online learning platform, wherein the gaze detection module is coupled to the webcam;
calibrating the gaze detection module for tracking eye movement of the user in real-time while the user is using the online learning platform;
capturing eye gaze data using the gaze detection module, wherein the eye gaze data identifies the gaze direction of the user's eyes while the user is accessing the online learning platform;
processing the captured eye gaze data for detection of one or more off-screen events while the user is using the online learning platform, wherein processing the captured eye gaze data comprises:
extracting one or more gaze details from the captured eye gaze data, wherein the gaze detail includes x and y coordinates of the user's eye position and a timestamp when the gaze detail is captured;
pre-defining screen edges, wherein the screen edges define an outer area of the screen;
comparing the extracted one or more gaze details with the pre-defined screen edges for identifying an off-screen event, wherein an alert is generated if the user's gaze location is identified outside the screen edges for a pre-defined time;
displaying the generated alert via a user interface on the online learning platform for notifying the user about the detected off-screen event.

2. The method of claim 1 wherein calibrating the gaze detection module further comprises:
employing one or more calibration techniques, by the gaze detection module, to adjust for the user's eye shape, size, and eye movement patterns, ensuring accurate and personalized eye gaze data capturing during online learning sessions.

3. The method of claim 1 wherein processing the captured eye gaze data further comprises utilizing a machine learning algorithm to identify the off-screen event.

4. The method of claim 3 wherein the machine learning algorithm personalizes the identification of off-screen event for individual users, comprises:
allowing the one or more machine learning algorithm to access past eye gaze data of the user including eye coordinates, pupil position, eye movement data, and head orientation data; and
learning from the past eye gaze data to calibrate the detection of off-screen events for the user.

5. The method of claim 1 wherein one or more off-screen events are detected when the user is looking beyond the pre-defined screen edges and one or more on-screen events are detected when the user is looking within the pre-defined screen edges.

6. The method of claim 1 wherein initializing the gaze detection module further comprises:
accessing one or more models for eye gaze tracking, wherein the one or more models include ridge regression model, tensor flow mesh model, and kalman filter.

7. The method of claim 1 wherein processing the captured eye gaze data for detection of one or more off-screen events further comprises:
assigning a constant value for screen edges;
defining screen bounds including a minimum value for screen width (minX), a maximum value for screen width (maxX), a minimum value for screen height (minY), and a maximum value for screen height (maxY);
comparing the x and y coordinates of the user's eye position for a time stamp to the defined screen bounds, wherein the x coordinate of the user's eye position is compared to the minimum and maximum values for the screen width and the y coordinate of the user's eye position is compared to the minimum and maximum values for the screen height;
identifying an off-screen event in at least one of the conditions where the value of x coordinate of the user's eye is less than the minimum value for screen width (minX), the value of x coordinate of the user's eye is more than the maximum value for screen width (maxX), if the value of y coordinate of the user's eye position is less than the minimum value for the screen height (minY), or the value of the y coordinate is more than the maximum value for the screen height (maxY).

8. The method of claim 7 wherein defining screen bounds further comprises:
calculating a minimum value of screen width using a formula “minX=screenWidth*screenedges”;
calculating a maximum value of screen width using a formula “maxX=screenWidth*(1−screenedges)”;
calculating a minimum value of screen height using a formula “minY=screenHeight*screenedges”; and
calculating a maximum value of screen height using a formula “maxY=screenHeight*(1−screenedges)”.

9. The method of claim 1 wherein the alert is generated if an engagement rate of the user is below 80% for at least 3 minutes, wherein the engagement rate is directly related to the number of on-screen events detected for captured eye gaze data.

10. The method of claim 1 wherein the real-time alerts to the user include adaptive suggestions tailored to re-engage the user based on detected off-screen gaze events.

11. The method of claim 1 wherein the processed eye gaze data is stored in a cloud database for efficient retrieval and analysis to evaluate the engagement patterns of the user and the online learning session quality.

12. The method of claim 1 wherein the stored eye gaze data is further analyzed using one or more analytics tools to create insights related to user engagement on the online learning platform, wherein the insights act as a feedback mechanism for enhancing user engagement on the platform.

13. A system comprising:
an online learning platform accessible via a user device, wherein the user device includes a user interface, a screen, and a webcam;
a gaze detection module integrated within the online learning platform to monitor the engagement behavior of a user accessing the online learning platform; wherein the gaze detection module is configured to:
calibrating the gaze detection module for tracking the eye movement of the user in real-time while the user is using the online learning platform;
capturing eye gaze data using the gaze detection module, wherein the eye gaze data identifies the gaze direction of the user's eyes while the user is accessing the online learning platform;
a gaze detector system to process the captured eye gaze data for detection of one or more off-screen events while the user is using the online learning platform comprises:
a streaming module to stream the captured eye gaze data in real-time;
a gaze processor configured to:
extracting one or more gaze details from the captured eye gaze data, wherein the gaze detail includes x and y coordinates of the user's eye position and a timestamp when the gaze detail is captured;
pre-defining screen edges, wherein the screen edges define an outer area of the screen;
comparing the extracted one or more gaze details with the pre-defined screen edges for identifying an off-screen event;
a notification module configured to:
generating an alert if the user's gaze location is identified outside the screen edges for a pre-defined time;
displaying the generated alert via the user interface to notify the user about the detected off-screen event.

14. The system of claim 14 wherein the gaze process further comprises a machine learning algorithm to identify the off-screen event.

15. The method of claim 14 wherein the machine learning algorithm personalizes the identification of off-screen events for individual users, comprises:
allowing one or more machine learning algorithms to access past eye gaze data of the user including eye coordinates, pupil position, eye movement data, and head orientation data; and
learning from the past eye gaze data to calibrate the detection of off-screen events for the user.

16. The system of claim 14 wherein the gaze processor detects one or more off-screen events when the user is looking beyond the pre-defined screen edges and one or more on-screen events are detected when the user is looking within the pre-defined screen edges.

17. The system of claim 14 wherein the pre-defined screen edges are dynamically adjustable based on user preferences or design requirements allows for flexible adaptation to different learning contexts and environments.

18. The system of claim 14 wherein the gaze processor utilizes image processing techniques like edge detection or feature extraction to compare the extracted eye gaze data with the predefined screen edges, enabling precise determination of the user's gaze location relative to screen bounds and facilitating the detection of off-gaze events.

19. The system of claim 14 wherein the notification module displays the generated alert via a chatbot window integrated within the online learning platform.

20. The system of claim 14 wherein the gaze detection module further comprises accessing one or more models for eye gaze tracking, wherein the one or more models include ridge regression model, tensor flow mesh model, and Kalman filter.

21. The system of claim 14 wherein the gaze processor is further configured to:
assigning a constant value for screen edges;
defining screen bounds including a minimum value for screen width (minX), a maximum value for screen width (maxX), a minimum value for screen height (minY), and a maximum value for screen height (maxY);
comparing the x and y coordinates of the user's eye position for a time stamp to the defined screen bounds, wherein the x coordinate of the user's eye position is compared to the minimum and maximum values for the screen width and the y coordinate of the user's eye position is compared to the minimum and maximum values for the screen height;
identifying an off-screen event in at least one of the conditions where the value of x coordinate of the user's eye is less than the minimum value for screen width (minX), the value of x coordinate of the user's eye is more than the maximum value for screen width (maxX), if the value of y coordinate of the user's eye position is less than the minimum value for the screen height (minY), or the value of the y coordinate is more than the maximum value for the screen height (maxY).

22. The system of claim 22 wherein the gaze detector defines the screen bounds by:
calculating a minimum value of screen width using a formula “minX=screenWidth*screenedges”;
calculating a maximum value of screen width using a formula “maxX=screenWidth*(1−screenedges)”;
calculating a minimum value of screen height using a formula “minY=screenHeight*screenedges”; and
calculating a maximum value of screen height using a formula “maxY=screenHeight*(1−screenedges)”.

23. The system of claim 14 wherein the notification module generates the alert if an engagement rate of the user is below 80% for at least 3 minutes, wherein the engagement rate is directly related to the number of on-screen events detected for captured eye gaze data.
